(19) United States
(12) Patent Application Publication
(10) Pub. No.: US 2026/0328740 A1
(43) Pub. Date: Oct. 22, 2026

(54) SINGLE TUBE SAMPLE PREPARATION AND CALIBRATION FOR BOTH SCREENING AND QUANTIFICATION OF ANALYTES

(71) Applicant: DH TECHNOLOGIES DEVELOPMENT PTE. LTD., Singapore (SG)

(72) Inventors: Aaron Stella, Derry, NH (US); Subhasish Purkayastha, Framingham, MA (US)

(21) Appl. No.: 19/109,475

(22) PCT Filed: Sep. 13, 2023
(86) PCT No.: PCT/IB2023/059103

§ 371 Date: Mar. 6, 2025

Related U.S. Application Data
(60) Provisional application No. 63/407,514, filed on Sep. 16, 2022.

(51) Int. Cl. G01N 30/86; G01N 1/40; G01N 30/72

(52) U.S. Cl. CPC G01N 30/8665; G01N 1/4044; G01N 30/7233

(57) ABSTRACT

The presently claims and described technology provides methods and kits for quantifying at least one analyte in a sample by mass analysis using a labeled isotopologues as an internal standards and to generate internal calibration curves.

### RELATED APPLICATIONS

The present patent application claims the priority benefit of U.S. Provisional Patent Application Ser. No. 63/407,514, filed Sep. 16, 2022, the content of which is hereby incorporated by reference in its entirety into this disclosure.

### BACKGROUND

Analytical samples, including biological samples and bodily liquids, can often provide critical analytical information. Presently, compounds of a related group (i.e., drugs and metabolites, hormones in a pathway, biomarkers, and/or peptides from a particular biologic drug) are generally screened for the presence of an analyte of interest and, if a screen is positive, a definitive, quantitative test is then performed to produce a reliably accurate result for a given sample. However, this requires that the original analytical sample be access and processed a second time, requiring additional labor, sample preparation reagents, and involves multiple steps to create an external calibration curve.

### SUMMARY

The inventors have recognized the need to combine multiple operations into a single sample reaction tube. This allows for screening and definitive testing in a single injection and provides for a more accurate screening test compared to traditional screen tests due to the presence of an internal calibration curve with an internal standard.

One aspect of the disclosure includes a method for quantifying at least one analyte in a sample by mass analysis, the method including adding a sample comprising an analyte of interest to a reaction mixture, the reaction mixture comprising at least a first labeled isotopologue and a second labeled isotopologue of the least one analyte of interest, ionizing the resulting mixture, monitoring, by mass spectrometry, at least one parent ion and/or at least one fragment ion of the analyte of interest, the first labeled isotopologue and/or the second labeled isotopologue, wherein the at least one fragment ion is selected from the group including a product ion, an isotopic ion, a product ion transition, and an isotopic ion transition; normalizing using the first labeled isotopologue; determining intensity and/or using natural isotopic abundance of the parent and at least one fragment of the second labeled isotopologue; generating an internal calibration curve based at least one product ion transition and/or at least one isotopic ion transition of the second labeled isotopologue; and quantifying the at least one analyte present in the sample using the calibration curve.

In some aspects, the reaction mixture includes at least a third labeled isotopologue, alternatively at least a fourth labeled isotopologue, alternatively at least a fifth labeled isotopologue. In another aspect, the second labeled isotopologue, third labeled isotopologue, fourth labeled isotopologue, and/or fifth labeled isotopologue is used to generate an internal calibration curve.

In some aspects, the first labeled isotopologue and second labeled isotopologue are labeled with at least one isotopic atom. In another aspect, the at least one isotopic atom is deuterium, carbon-13, nitrogen-15, or oxygen-18. In yet a further aspect, the isotopic atom of the first labeled isotopologue and the isotopic atom of the second labeled isotopologue are different.

In some aspect, the normalization with first labeled isotopologue further includes using peak area of the parent or product ion of the first labeled isotopologue and peak area of the parent or product ion of the analyte and/or the second labeled isotopologue to calculate a peak area ratio, and normalizing the analyte and/or the second labeled isotopologue using said peak area ratio.

In some aspects, the product ion transition has an intensity and/or abundance of about 100%. In another aspect, the product ion transition is the most intense and/or abundant isotope of the at least one analyte. In some aspects, the intensity and/or abundance of the isotopic ion transition is less than about 100%, alternatively less than about 50%, alternatively less than about 25%, alternatively less than about 15%, alternatively less than about 10%, alternatively less than about 5% than a precursor and/or the product ion transition. In some aspects, determining the intensity and/or abundance of the at least one product ion transition and/or isotopic ion transition comprises obtaining mass spectrum data corresponding to the at least one product ion transition and/or isotopic ion transition.

In some aspects, at least two analytes are quantified, alternatively at least three analytes are quantified, alternatively at least four analytes are quantified, alternatively at least five analytes are quantified, alternatively at least six analytes are quantified, alternatively at least seven analytes are quantified, alternatively at least eight analytes are quantified, alternatively at least nine analytes are quantified, alternatively at least ten analytes are quantified.

In some aspects, at least two product ion transitions are monitored, alternatively at least three product ion transitions are monitored, alternatively at least four product ion transitions are monitored, alternatively at least five product ion transitions are monitored, alternatively at least six product ion transitions are monitored, alternatively at least seven product ion transitions are monitored, alternatively at least eight product ion transitions are monitored, alternatively at least nine product ion transitions are monitored, alternatively at least ten product ion transitions are monitored.

In an aspect, the intensity difference between the first labeled isotopologue and/or second labeled isotopologue and the analyte of interest are used as a response factor for signal intensity normalization. In another aspect, the first labeled isotopologue and/or second labeled isotopologue and the analyte of interest are at the same concentration.

In some aspects, at least two isotopic ion transitions are monitored, alternatively at least three isotopic ion transitions are monitored, alternatively at least four isotopic ion transitions are monitored, alternatively at least five isotopic ion transitions are monitored, alternatively at least six isotopic ion transitions are monitored, alternatively at least seven isotopic ion transitions are monitored, alternatively at least eight isotopic ion transitions are monitored, alternatively at least nine isotopic ion transitions are monitored, alternatively at least ten isotopic ion transitions are monitored.

In some aspects, the method further includes using the intensity and/or abundance of the at least one product ion transition and/or the at least one isotopic ion transition of the second labeled isotopologue to calculate a ratio of the at least one product ion transition and/or the at least one isotopic ion transition to the product and/or precursor, and using the calculated ratio to calculate an isotopic dilution factor (IDF), wherein the IDF is used as a multiplier to compensate for high concentrations of analyte of interest.

In some aspects, the reaction mixture further comprises magnetic beads. In another aspect, the magnetic beads are selected from the group consisting of mixed-phase magnetic beads, affinity ligand-conjugated magnetic beads, enzyme-conjugated magnetic beads, ion exchange magnetic beads, ferromagnetic beads, paramagnetic beads, superparamagnetic beads, and combinations thereof. In a further aspect, the mixed-phase magnetic beads are selected from C4 magnetic beads, C8 magnetic beads, C12 magnetic beads, C18 magnetic beads, cyanopropyl magnetic beads, phenyl magnetic beads, diphenyl magnetic beads, and combinations thereof. In yet another aspect, the sample is desalted using the mixed-phase magnetic beads. In another aspect, the enzyme-conjugated magnetic beads are conjugated with trypsin, chymotrypsin, glucuronidase, or combinations thereof. In a further aspect, the sample is digested and/or hydrolyzed using the enzyme-conjugated magnetic beads. In yet another aspect, the sample is eluted from the magnetic beads prior to being ionized.

In an aspect, the mass spectrometry is conducted using a mass analyzer. In another aspect, the mass analyzer is coupled to a sample introduction device. In a further aspect, the sample introduction device comprises an acoustic droplet ejector (ADE), a solid phase extraction system, liquid-liquid extraction, protein precipitation, a liquid aspiration system, a microinjector, a nanoinjector, an inkjet printer nozzle, a chromatography instrument, microflow system, solid phase extraction system, differential mobility spectrometer, a trap-and-elute workflow, an open port interface, or direct flow injection. In another aspect, the sample introduction comprises acoustically ejecting the liquid sample into a mobile phase at an open port interface (OPI) using the acoustic droplet ejector (ADE). In an aspect, the chromatography instrument is a high performance liquid chromatography (HPLC) instrument, an ultra high performance liquid chromatography instrument (UPLC), Micro liquid chromatography, or Nano liquid chromatography.

In an aspect, the mass analyzer is configured to perform a first mass analysis on the sample, wherein the first mass analysis is mass screening for an analyte of interest in the sample, and wherein if the analyte of interest is detected in the sample, the mass analyzer is configured to perform a second mass analysis, wherein the second mass analysis is a quantitative analysis. In another aspect, the mass analyzer is a tandem mass spectrometer. In a further aspect, the first mass analysis is performed using a first mass analyzer and the second mass analysis is performed using a second mass analyzer.

In an aspect, the first mass analyzer is a single-stage mass spectrometer or a tandem mass spectrometer. In another aspect, the single-stage mass spectrometer is selected from the group consisting of magnetic sector, quadrupole, time-of-flight (TOF), and ion traps.

In an aspect, the second mass analyzer is a tandem mass spectrometer. In another aspect, the tandem mass spectrometer is selected from the group consisting of a triple quadrupole, a quadrupole-linear ion trap, a quadrupole TOF, and a TOF-TOF.

In an aspect, the sample is a biological sample. In another aspect, the biological sample is selected from the group consisting of urine, blood, oral fluid, plasma, tissue, bone marrow, and tumor samples.

In an aspect, the method is used in a clinical analysis workflow. In another aspect, the clinical analysis is used to screen for drugs of abuse, peptide markers for disease states, and/or peptides from proteins and/or analytes of interest. In a further aspect, the drugs of abuse are selected from the group consisting of amphetamines, methamphetamines, benzodiazepines, barbiturates, marijuana, cocaine, PCP, methadone, opioids (narcotics), fentanyl, norfentanyl, gabapentin, and pregabalin.

One aspect of the disclosure includes a kit for quantifying at least one analyte in a sample by mass analysis, the kit including at least a first labeled isotopologue and a second labeled isotopologue of the least one analyte of interest, and magnetic beads. In an aspect, the magnetic beads are selected from the group consisting of mixed-phase magnetic beads, affinity ligand-conjugated magnetic beads, enzyme-conjugated magnetic beads, ion exchange magnetic beads, ferromagnetic beads, paramagnetic beads, superparamagnetic beads, and combinations thereof. In a further aspect, the kit comprises mixed-phase magnetic beads, enzyme-conjugated magnetic beads and ferromagnetic beads. In yet a further aspect, the first labeled isotopologue, second labeled isotopologue and magnetic beads are in a single reaction mixture. In still a further aspect, wherein the single reaction mixture is added to a sample comprising an analyte to be quantified.

### BRIEF DESCRIPTION OF THE DRAWINGS

Aspects of the present disclosure will now be described, by way of example only, with reference to the attached Figures, wherein:

FIGS. 1A-1C depict structures of different isotopologues of fentanyl.

FIG. 2 depicts an internal isotopic calibration curve according to an aspect of the disclosure.

FIG. 3 depicts the peak intensities of an analyte of interest, an internal standard (a first labeled isotopologue), and high, middle, and low isotopic calibrants (generated from a second labeled isotopologue) according to an aspect of the disclosure.

FIG. 4 depicts a single reaction mixture according to an aspect of the disclosure.

FIG. 5 shows isotopic MRMs for fentanyl-d5 and norfentanyl-d5 selected to generate a calibration curve according to an aspect of the disclosure.

FIG. 6 shows the samples with known concentrations of fentanyl and norfentanyl analyzed using acoustic ejection mass spectrometry with isotopologues for the internal standard and an internal calibration curve according to an aspect of the disclosure.

FIG. 7 shows semi-quantitative results for samples with known concentrations of fentanyl and norfentanyl analyzed using acoustic ejection mass spectrometry with isotopologues for the internal standard and an internal calibration curve according to an aspect of the disclosure.

FIG. 8 shows the reproducibility for an internal standard isotopologue according to an aspect of the disclosure.

FIG. 9 shows the reproducibility of an internal calibration isotopologue according to an aspect of the disclosure.

FIGS. 10A and 10B depicts a method comparison for fentanyl between AMES and LC-MS/MS.

FIGS. 11A-11C depicts samples analyzed using AEMS and LC-MS/MS according to an aspect of the disclosure.

### DETAILED DESCRIPTION

It is to be understood that this disclosure is not limited to the particular methodology, protocols, and reagents described herein and as such may vary. It is also to be understood that the terminology used herein is for the purpose of describing particular aspects only and is not intended to limit the scope of the present disclosure or the appended claims.

Unless otherwise defined, all technical and scientific terms used herein have the same meaning as commonly understood by one of ordinary skill in the art to which the methods described herein belong.

The singular form “a”, “an” and “the” include plural referents unless the context clearly dictates otherwise. These articles refer to one or to more than one (i.e., to at least one). The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The term “about” as used in connection with a numerical value throughout the specification and the claims denotes an interval of accuracy, familiar and acceptable to a person skilled in the art. In general, such interval of accuracy is +/−10%.

Where ranges are given, endpoints are included. Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise.

The term “exemplary” means serving as a non-limiting example, instance, or illustration. As utilized herein, the terms “e.g.,” and “for example” set off lists of one or more non-limiting aspects, examples, instances, or illustrations.

Aspects of this disclosure include a methods for quantifying at least one analyte in a sample by mass analysis. The sample may be a biological sample. Biological samples may be biological fluids, which may include, but are not limited to, blood, plasma, serum, oral fluid, or other bodily fluids or excretions, such as but not limited to saliva, urine, cerebrospinal fluid, lacrimal fluid, perspiration, gastrointestinal fluid, amniotic fluid, mucosal fluid, pleural fluid, sebaceous oil, exhaled breath, and the like. The biological sample may also be tissue (including tissue biopsies), bone marrow, tumor samples, and other biological samples and materials derived therefrom. The sample may also be a chemical sample. Chemical samples may include any type of sample including chemicals, including, but not limited to, water samples. The sample may also be an environmental sample. Non-limiting examples of environmental samples may include air, soil, and wastes (liquids, solids or sludges). The sample may also be a food sample and the food sample may be solid, semisolid, viscous, or liquid. The food sample may also be used to test for food safety, including microbial or bacterial analysis. The sample may also be dissolved in solvent. The solvent may be a liquid, a solid, a gas, or a supercritical fluid. The solvent may be a polar or non-polar solvent. The solvent may be organic solvent. The solvent may be water, including deionized water. The sample may be mixed with a matrix material. A non-limiting example of a matrix material includes crystalline compounds. The sample may also be dissolved into a solution, incorporated into a liquid, or a component in a homogenous system.

An analyte may include a substance whose presence, absence, or concentration is to be determined according to methods of the present disclosure. Typical analytes may include, but are not limited to, organic molecules, hormones (such as thyroid hormones, estradiol, testosterone, progesterone, estrogen), metabolites (such as glucose or ethanol), proteins, lipids, carbohydrates, and sugars, steroids (such as Vitamin D), peptides (such as procalcitonin), nucleic acid segments, biomarkers (pharmaceuticals such as antibiotics, benzodiazepine), drugs (such as immunosuppressant drugs, narcotics, opioids, etc.), molecules with a regulatory effect in enzymatic processes such as promoters, activators, inhibitors, or cofactors, microorganisms (such as viruses (including EBV, HPV, HIV, HCV, HBV, Influenza, Norovirus, Rotavirus, Adenovirus, etc.), bacteria (H. pylori, Streptococcus, MRSA, C. diff, Ligionella, etc.), fungus, parasites (plasmodium, etc.), cells, cell components (such as cell membranes), spores, nucleic acids (such as DNA and RNA), etc. Aspects of the disclosure can also allow for the simultaneous analysis of multiple analytes in the same class or different classes (e.g., simultaneous analysis of metabolites and proteins). In an aspect of the disclosure, the method is used to prepare the sample for clinical analysis. The clinical analysis can be used to screen peptide markers for disease states. The clinical analysis can also be used to screen for drugs of abuse. Non-limiting examples of drugs of abuse include amphetamines, methamphetamines, benzodiazepines, barbiturates, marijuana, cocaine, PCP, methadone, opioids (narcotics), fentanyl, norfentanyl, gabapentin, and pregabalin. In an aspect, the clinical analysis is a clinical urine test or a urinalysis, and the analysis is used to screen for drugs of abuse. Urine is a common biological sample used in testing for drugs of abuse. A urinalysis or clinical urine test can detect the presence of a drug of abuse after the drug effects have worn off.

In an aspect, the sample may be added to a reaction mixture. The reaction mixture may include a first labeled isotopologue and a second labeled isotopologue of the least one analyte of interest. An isotopologue is a molecule that differs only in their isotopic composition from the stable compound. Isotopologue have the same chemical formula and bonding arrangement of atoms, but at least one atom has a different number of neutrons than the parent. For example, isotopologues of water include the replacement of both hydrogen atoms with deuterium isotopes of hydrogen (e.g., heavy water) and the replacement of oxygen with the oxygen-18 isotope (e.g., heavy oxygen water). The first labeled isotopologue and second labeled isotopologue may be labeled with at least one isotopic atom, but depending on the chemical structure, if the analyte of interest has several atoms of the same element, any one (or all) of them can be altered. Any isotopic atom may be used to label the first labeled isotopologue and a second labeled isotopologue including, but not limited to, deuterium, carbon-13, nitrogen-15, or oxygen-18. Also depending on the analysis desired, the isotopic atom of the first labeled isotopologue and the isotopic atom of the second labeled isotopologue are different. The reaction mixture may further include a third labeled isotopologue, fourth labeled isotopologue, and/or fifth labeled isotopologue.

In an exemplary method, the reaction mixture may further include magnetic beads. Magnetic beads or magnetic particles are typically nanoparticles or microparticles that have paramagnetic properties. Magnetic beads or magnetic particles are typically hydrophilic and disperse easily in aqueous solutions. The surface coating and/or chemistry of the magnetic beads or magnetic particles allow various biomolecules such as proteins, peptides, and nucleic acids to bind to the magnetic beads or magnetic particles. Once a biomolecule of interest is bound to a magnetic bead or magnetic particle, magnetic separation is employed to the magnetic beads or magnetic particles from a suspension by applying a magnetic force. Non-limiting examples of magnetic beads include mixed-phase magnetic beads, affinity ligand-conjugated magnetic beads, enzyme-conjugated magnetic beads, ion exchange magnetic beads, ferromagnetic beads, paramagnetic beads, superparamagnetic beads, and combinations thereof.

Desalting prior to ionization may improve ionization efficiency and may also purify and concentrate the sample. The sample may be desalted using mixed-phase magnetic beads, including, but not limited to, C4 magnetic beads, C8 magnetic beads, C12 magnetic beads, C18 magnetic beads, cyanopropyl magnetic beads, phenyl magnetic beads, diphenyl magnetic beads, and combinations thereof. The use of C4, C8, C12, or C18 magnetic beads, for example, retains nonpolar solutes, such as peptides.

Enzymatic hydrolysis is a process where peptide bonds in proteins are hydrolyzed using enzymes, such as proteases, peptidases, or peptide hydrolases. Proteases can be either exopeptidases, which act near the end of a polypeptide chain and include, for example, aminopeptidases and dipeptidyl peptidases, or endopeptidases, which act on nonterminal peptide bonds and include, for example, serine proteases, cysteine proteases, aspartic acid proteases, and metallo endopeptidases. Enzymatic hydrolysis can also include the use of the glycosidase family of enzymes that catalyze the breakdown of complex carbohydrates. Suitable hydrolysis enzymes include, but are not limited to, β-glucuronidase, glucuronidase, trypsin, chymotrypsin, a protease, LysC, LysN, AspN, GluC, ArgC, pronase, pepsin, and prolidase. Suitable hydrolysis enzymes also include those capable of hydrolyzing glyosidic linkages, such as those formed during metabolic processes. Ferromagnetic beads, paramagnetic beads, and/or superparamagnetic beads may also be used to stir the reaction mixture and the sample may be eluted from the magnetic beads prior to being ionized.

In an exemplary aspect, the mixture of the sample with the isotopologue may be ionized using an ionization method known in the art. Non-limiting ionization methods include chemical ionization (CI), electron impact ionization (EI), fast atom bombardment (FAB), electrospray ionization (ESI), atmospheric pressure chemical ionization (APCI), laser ionization (LIMS), matrix assisted laser desorption ionization (MALDI), plasma-desorption ionization (PD), resonance ionization (RIMS), secondary ionization (SIMS), and thermal ionization (TIMS).

In an aspect, the method further includes monitoring, by mass spectrometry, at least one parent or product ion of the analyte of interest and at least one isotopic ion transition for the first labeled isotopologue and the second labeled isotopologue.

The monitoring of the product ion transition and/or isotopic ion transition for the at least one analyte may also include monitoring an isotopic abundance for at least one ion pair of the at least one analyte. As long as the mass-to-charge ratio (m/z) for the analytes of interest and/or corresponding ion pairs do not overlap, an infinite number of ion pairs can be monitored. This allows for the quantification of multiple analytes in one sample. In exemplary methods, two analytes are quantified, alternatively at least three analytes are quantified, alternatively at least four analytes are quantified, alternatively at least five analytes are quantified, alternatively at least six analytes are quantified, alternatively at least seven analytes are quantified, alternatively at least eight analytes are quantified, alternatively at least nine analytes are quantified, alternatively at least ten analytes are quantified.

Product ion transition monitoring is a technique in which the m/z range of a first mass separator is specifically selected to transmit a molecular ion (often referred to as “the parent ion” or “the precursor ion”) to an ion fragmentor to produce fragment ions (often referred to as “daughter ions” or “product ion”). The transmitted m/z range of a second mass separator is selected to transmit one or more product ions to a detector that measures the product ion signal. The observed m/z ratio (and may also referred to as “mass data”) of a parent (or precursor) ion and its corresponding product (or daughter) ion is a product ion transition. This ion transition may also be referred to as a precursor-product ion transition or a product-daughter ion transition. In a multiple reaction monitoring (“MRM”) workflow, two or more transitions are monitored, each corresponding to a different fragment or product ion. For example, the parent ion of morphine is 286, and the most intense ions created by the fragmentation of 286 are 201, 181, and 165. As such, the three product ion transitions for morphine are 286→201, 286→181, and 286→165.

In other exemplary methods, at least two product ion transitions are monitored, alternatively at least three product ion transitions are monitored, alternatively at least four product ion transitions are monitored, alternatively at least five product ion transitions are monitored, alternatively at least six product ion transitions are monitored, alternatively at least seven product ion transitions are monitored, alternatively at least eight product ion transitions are monitored, alternatively at least nine product ion transitions are monitored, alternatively at least ten product ion transitions are monitored. In some exemplary methods, the product ion has an intensity and/or abundance of about 100%. In some exemplary methods, the product ion is the most intense and/or abundant isotope of the at least one analyte.

In an isotopic multiple reaction monitoring (“Isotopic MRM”), the workflow utilizes the ion transitions based on the natural isotopic abundance of analytes. This ion transition may also be referred to as a precursor-isotopic ion transition or isotopic ion transition. For example, there are two stable isotopes of chlorine; chlorine 35 (75.8 % natural abundance) and chlorine 37 (24.2 % natural abundance). In general, each natural isotopic ion's relative abundance value is different from another in a proportionally decreasing fashion. For example, the intensity and/or abundance of the isotopic ion is less than about 100%, alternatively less than about 50%, alternatively less than about 25%, alternatively less than about 15%, alternatively less than about 10%, alternatively less than about 5% than a precursor and/or the product ion. The natural isotopic daughter ion acts as an internal standard, allowing for quantification of the analyte without requiring the addition of a calibrant or stable-isotope labeled analyte.

In other exemplary methods, at least two isotopic ion transitions are monitored, alternatively at least three isotopic ion transitions are monitored, alternatively at least four isotopic ion transitions are monitored, alternatively at least five isotopic ion transitions are monitored, alternatively at least six isotopic ion transitions are monitored, alternatively at least seven isotopic ion transitions are monitored, alternatively at least eight isotopic ion transitions are monitored, alternatively at least nine isotopic ion transitions are monitored, alternatively at least ten isotopic ion transitions are monitored.

The methods of this disclosure can be practiced using mass spectrometers single-stage mass spectrometers or that have the ability to select and fragment molecular ions, for example, tandem mass spectrometers, i.e., mass spectrometers that have two mass separators with an ion fragmentor disposed in the ion flight path between the two mass separators. Non-limiting examples of mass separators include, but are not limited to, quadrupoles, RF multipoles, ion traps, time-of-flight (TOF), and TOF in conjunction with a timed ion selector. Non-limiting examples of ion fragmentors include, but are not limited to, those operating on the principles of collision induced dissociation (CID, also referred to as collisionally assisted dissociation (CAD)), photoinduced dissociation (PID), surface induced dissociation (SID), post source decay, by interaction with an electron beam (e.g., electron induced dissociation (EID), electron capture dissociation (ECD)), interaction with thermal radiation (e.g., thermal/black body infrared radiative dissociation (BIRD)), post source decay, or combinations thereof.

Non-limiting examples of a single-stage mass spectrometry system includes magnetic sector, quadrupole, time-of-flight (TOF), and ion traps. Non-limiting examples of tandem mass spectrometry systems for mass analysis include, but are not limited to, those which comprise one or more of a triple quadrupole, a quadrupole-linear ion trap (e.g., QTRAP® System), a quadrupole TOF (e.g., TripleTOF® System), and a TOF-TOF. In some non-limiting aspects, a mass analyzer is configured to perform a first mass analysis on the sample, wherein the first mass analysis is mass screening for an analyte of interest in the sample, and wherein if the analyte of interest is detected in the sample, the mass analyzer is configured to perform a second mass analysis, wherein the second mass analysis is a quantitative analysis.

In an aspect, the sample may be transferred from the sample introduction device to the mass analyzer using transfer techniques generally known in the art such as, for example, techniques including a microinjector, a nanoinjector, an inkjet printer nozzle, an acoustic droplet ejector (ADE), a solid phase extraction system, or a liquid aspiration system. While the transferred volumes may vary, typical volumes of transferred solutions fall within a range of about 2.5 nL to about 500 nL.

Non-limiting examples of the sample introduction device include a chromatography instrument (such as a high performance liquid chromatography (HPLC) instrument, an ultra high performance liquid chromatography instrument (UPLC), micro liquid chromatography, or nano liquid chromatography), microflow system, solid-phase extraction system, liquid-liquid extraction, protein precipitation, differential mobility spectrometer, a trap-and-elute workflow, an open port interface, or direct flow injection. In an aspect, the sample solution may be introduced to the ion source by acoustically ejecting the sample into a mobile phase at an open port interface (OPI) using the acoustic droplet ejector (ADE).

In some aspects, the combination of open port interface (OPI) and acoustic droplet ejection (ADE) is referred to as Acoustic Ejection Mass Spectrometry (AEMS). Examples of acoustic ejection mass spectrometry systems for qualitative mass analysis include an Echo® MS System.

It will further be appreciated that any number of additional elements can be included in the sample processing system including, for example, an ion mobility spectrometer (e.g., a differential mobility spectrometer for ion selection) that is disposed between the ionization chamber and the mass analyzer and is configured to separate ions based on their mobility through a drift gas in high- and low-fields rather than their mass-to-charge ratio. Additionally, it will be appreciated that the mass analyzer can comprise a detector that can detect the ions which pass through the mass analyzer and can, for example, supply a signal indicative of the number of ions per second that are detected.

In an exemplary method, the first labeled isotopologue is an internal standard that is used for normalization. In a non-limiting example, normalization with first labeled isotopologue includes using the peak area of the parent or product ion of the first labeled isotopologue and the peak area of the parent or product ion of the analyte and/or the second labeled isotopologue to calculate a peak area ratio. The analyte and/or the second labeled isotopologue is then normalized using said peak area ratio. In some methods, the intensity difference between the first labeled isotopologue and/or second labeled isotopologue and the analyte of interest may be used as a response factor for signal intensity normalization. In this method, the first labeled isotopologue and/or second labeled isotopologue and the analyte of interest may be at the same concentration.

The second labeled isotopologue (and any subsequent labeled isotopologue) may be used for the generation an internal calibration curve. The intensity, or area, of a product ion transition or isotopic ion transition depends on several factors including concentration, ease of ionization, and fragmentation efficiency. The peak areas for product ion transitions or isotopic ion transitions are integrated as measures of product ion or isotopic ion abundance and serve as the basis for quantitative comparisons. To quantify an analyte using product ion transitions or isotopic ion transitions, the signal intensity or relative abundance of the product ion and/or isotopic ion is compared to, for example, an internal calibration curve constructed using one or more labeled isotopologues and/or by calculating a ratio of at least one isotopic ion transition to the corresponding analyte, and quantifying the amount of the analyte in the sample using the calculated ratio. Depending on the analyte of interest, the calibration curve may be generated using at least one product ion transition, at least one isotopic ion transition, or a combination of both. The internal calibration curve may be constructed by using the natural isotopic abundance of one isotopologue, by using multiple differently labeled isotopologues of different concentrations, or combinations of these methods.

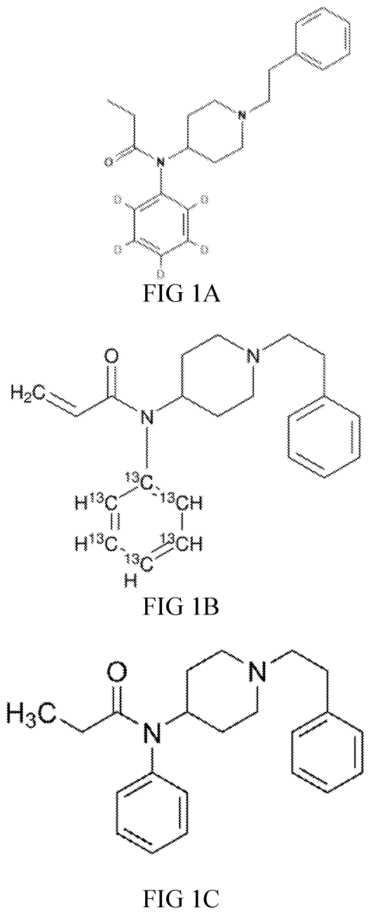

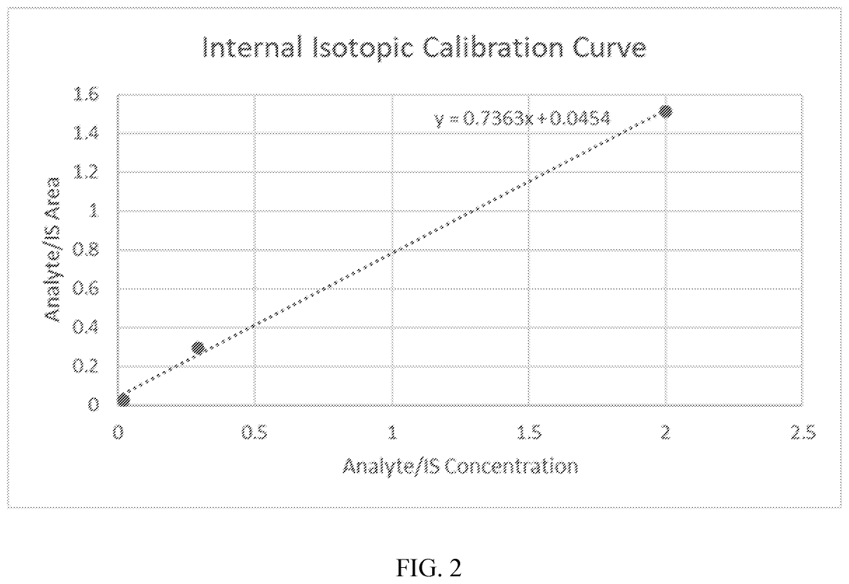

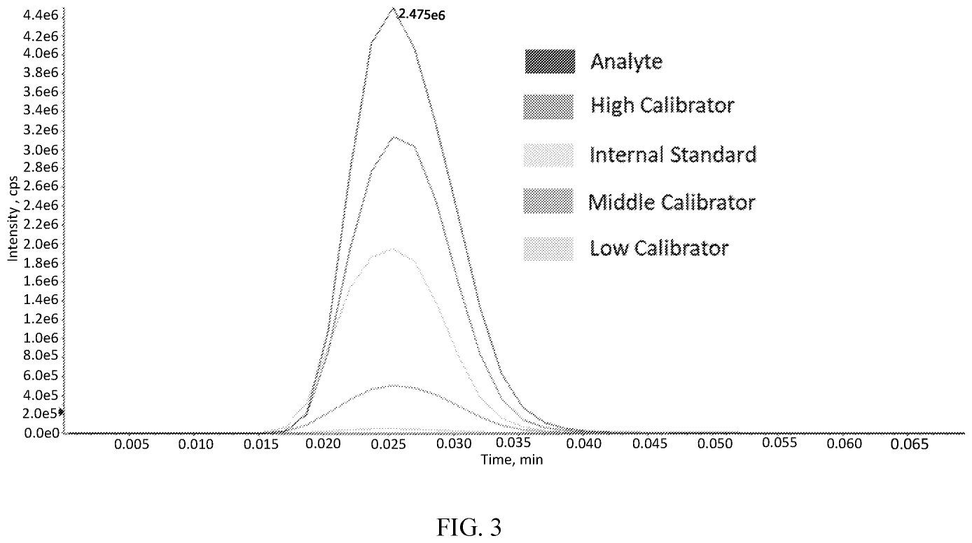

In a non-limiting example, a calibration curve is generated for fentanyl. FIGS. 1A-1C depict structures of different isotopologues of fentanyl. FIG. 1A is fentanyl-d5 (MW=341.50), FIG. 1B is fentanyl-13C6 (MW=342.43), and FIG. 1C is fentanyl (MW=336.47, no isotopic label). The unlabeled fentanyl is used to quantify the unknowns and either of the isotopologues could be used for an internal standard. To generate the calibration curve, the natural isotopic abundance of either one or both of the labeled isotopologues to generate a calibration curve with isotopic MRMs that do not interfere with the analyte or the internal standard MRM channel. FIG. 2 depicts an internal isotopic calibration curve according to an aspect of the disclosure. FIG. 3 depicts the peak intensities of an analyte of interest, an internal standard (a first labeled isotopologue), and high, middle, and low isotopic calibrants (generated from a second labeled isotopologue) according to an aspect of the disclosure.

The calculated ratio may be used to calculate an isotopic dilution factor (“IDF”). This IDF may be used as a multiplier to compensate for abundance differences between the naturally occurring abundant isotopes and the corresponding analyte and/or precursor. In some aspects, the precursor is most abundant isotope. In some aspects, the isotope MRM conditions may be auto-optimized. For example, the theoretical isotope intensity ratio of both precursor and isotopic ions, and the desired intensity level is used to choose the isotope MRM conditions. In a non-limiting example, the most abundant transition peak is the peak that is used to quantify the majority of the samples. The isotopic ion transition peak is a peak of lower abundance that can be used as a dilution factor. The factor difference between the quantifying transition and isotopic ion transition can be easily determined and applied to samples which require quantification using the isotopic ion transition.

By adding a sample to the disclosed reaction mixture, sample preparation be performed in under 10 minutes, alternatively under 9 minutes, alternatively under 8 minutes, alternatively under 7 minutes, alternatively under 6 minutes, alternatively under 5 minutes, alternatively under 4 minutes, alternatively under 3 minutes, alternatively under 2 minutes, or alternatively under 1 minute. Additionally, the resulting sample preparation product can be used for both screening and definitive testing. The disclosed methods allow for simple sample preparation that can be performed manually (point of care application) or with automation (for large batches). Due to the presence of an internal calibration curve with an internal standard in the reagent, the screening test can now be classified as a semi-quantitative test which provides a user with a greater level of knowledge about each individual sample before the sample is quantitatively analyzed on the definitive testing platform. Additionally, the combination of internal calibration curve and internal standard for each individual sample ensures that matrix effects are neutralized. Comparing results from an unknown sample to an external calibration curve can often ignore sample matrix effects. In a non-limiting example, the use of the reaction mixture reduces matrix effects and at the same time desalts the sample. Furthermore, the use of internal calibration enables random access testing, enabling emergency testing and point of care testing with a mass spectrometer.

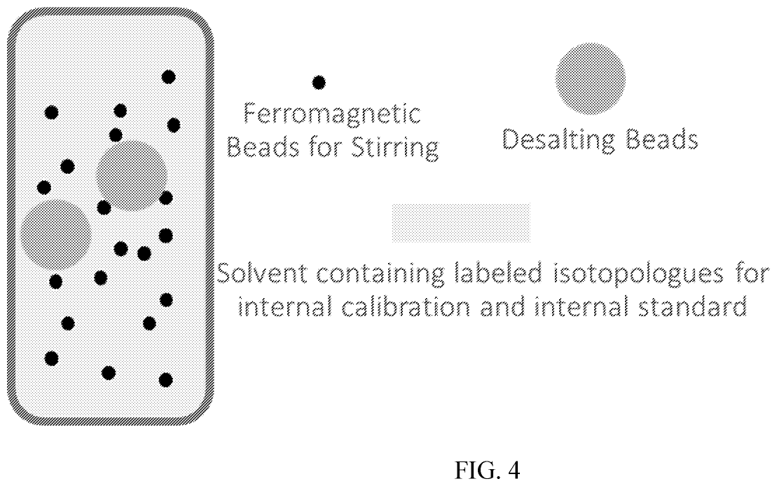

In some aspects, there may be a kit included for carrying out the disclosed methods. The kit may include at least a first labeled isotopologue and a second labeled isotopologue of the least one analyte of interest and magnetic beads. The magnetic beads may include, but are not limited to, the magnetic beads are selected from the group consisting of mixed-phase magnetic beads, affinity ligand-conjugated magnetic beads, enzyme-conjugated magnetic beads, ion exchange magnetic beads, ferromagnetic beads, paramagnetic beads, superparamagnetic beads, and combinations thereof. In a non-limiting example, the first labeled isotopologue, second labeled isotopologue and magnetic beads are in a single reaction mixture. As shown in FIG. 4, the reaction mixture includes the first labeled isotopologue, second labeled isotopologue, ferromagnetic beads, and desalting beads. The single reaction mixture may also be housed in a container. Non-limiting examples of suitable contains include, test tubes, centrifuge tubes, vials, cups, or bottles. In some aspects, the container is a sample plate, the sample plate comprising a plurality of sample wells. The sample wells may contain the sample which the reaction mixture is added to. Depending on the analysis desired, the sample wells may contain several different samples and/or calibrants.

### EXAMPLES

An equal amount of Phenomenex 100 ferromagnetic beads and mixed-phase micro-sized, paramagnetic desalting beads were suspended in a solution of 95/5 water/methanol. 500 ng/ml of fentanyl-d5, 500 ng/ml of norfentanyl-d5, 200 ng/ml of fentanyl-¹³C₆, and 200 ng/ml of norfentanyl-¹³C₆ were added to the magnetic beads solution.

The sample is collected using any specimen collection method know in the art. Urine samples can be collected according to the SAMHSA guidelines (Substance Abuse and Mental Health Services Administration Center for Substance Abuse Prevention), available at https://www.samhsa.gov/sites/default/files/specimen-collection-handbook-2014.pdf. Urine specimens are typically submitted to certified laboratories within 24 hours after collection.

50 μL of the reaction mixture was added to 50 μL of the sample. Electromagnets were used to mix the sample mixture and a magnetic rack is used to pull the magnetic beads with to one side of the reaction vessel. The supernatant was removed and the magnetic beads were washed with 200 μL of di water and 65 μL to elute the desalted sample. Electromagnets were used to mix the sample mixture and a magnetic rack is used to pull the magnetic beads with to one side of the reaction vessel. 50 μL was the supernatant and 10 μL of water were added to an acoustic ejection mass spectrometry (AMES) 384-well plate. The plate was then shook on a planar rotator.

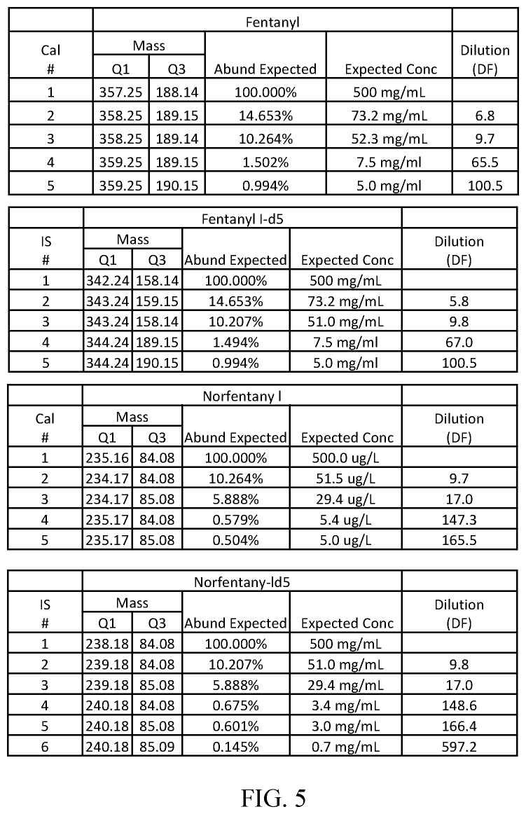

Using AMES, and as shown in FIG. 5 the MRM transitions for fentanyl monitored were 327.25→188.14 (analyte of interest); 343.2→105.1 (internal standard); and 342.24→188.14, 343.25→189.15, and 344.24→190.15 (calibration curve). The MRM transitions for norfentanyl monitored were 233.16→84.08 (analyte of interest); 239.1→156.1 (internal standard); and 238.18→84.08, 240.18→84.08, and 240.18→85.08 (calibration curve). The peak areas for the three isotopic MRMs for fentanyl and norfentanyl were corrected with a response factor adjustment derived from the respective internals standards. These isotopic MRMs were also chosen so that they do not interfere with the internal standard.

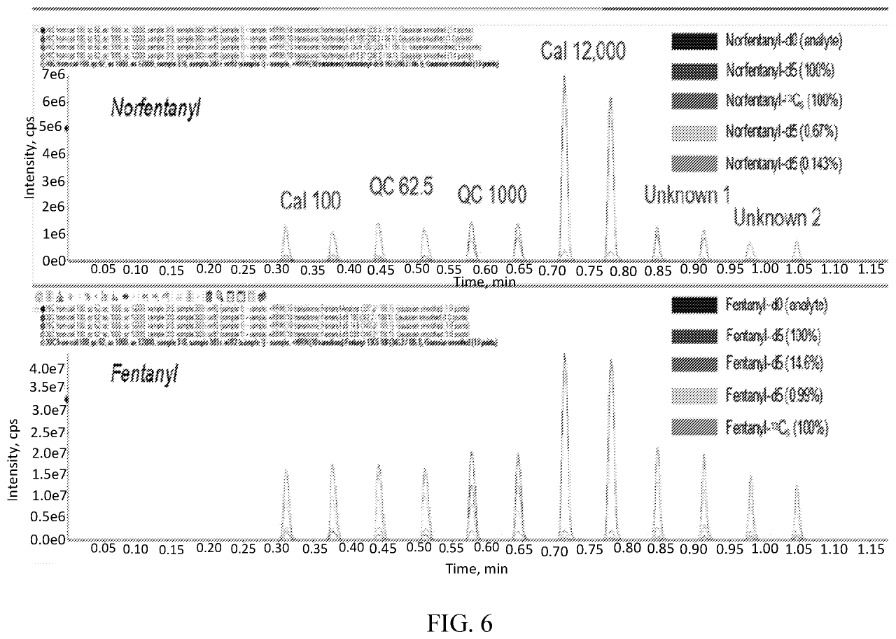

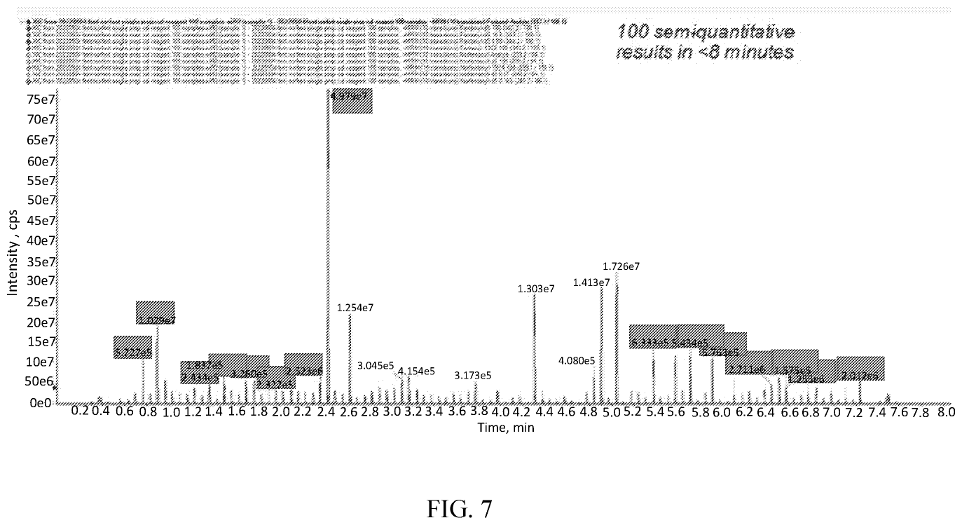

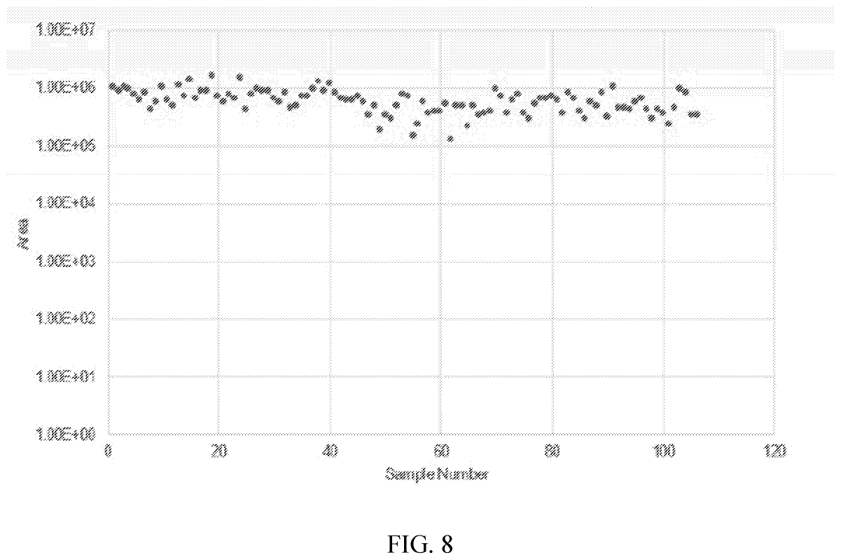

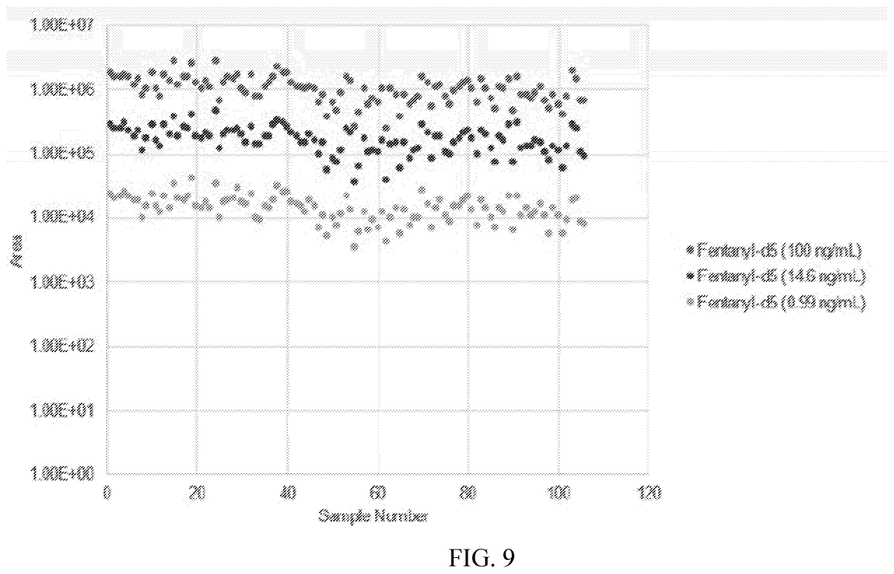

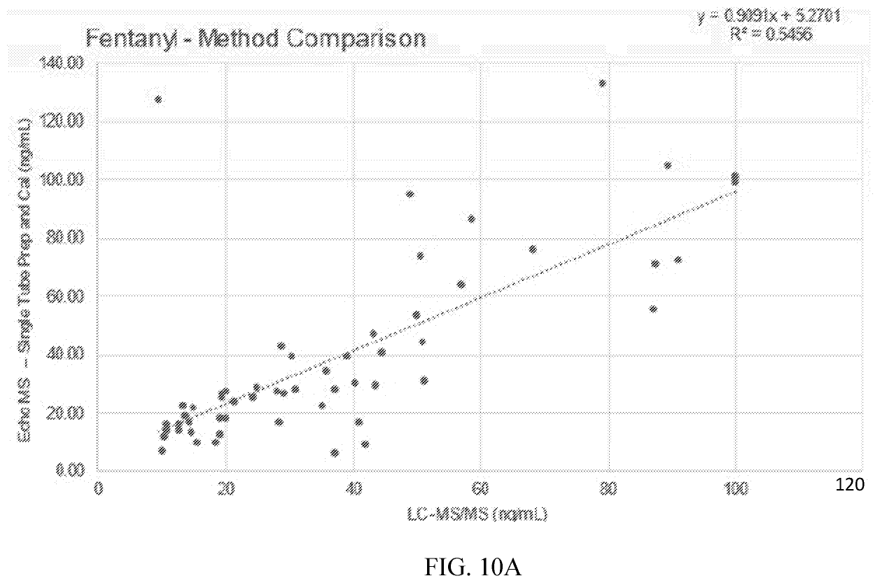

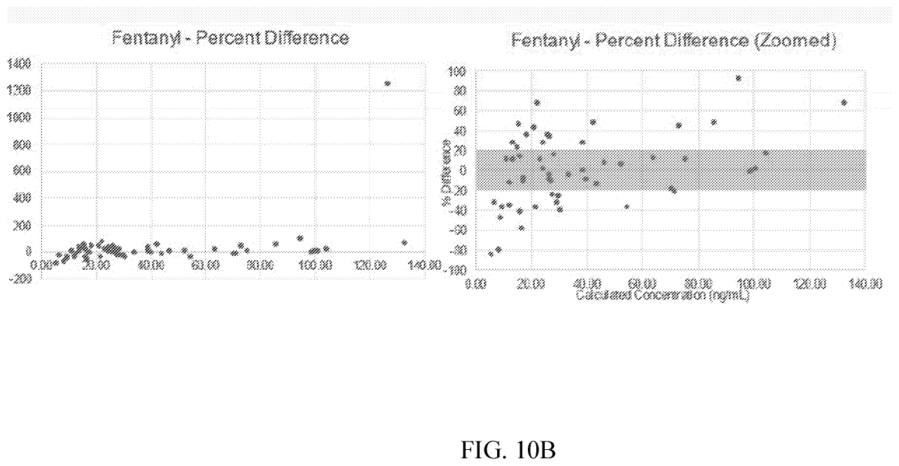

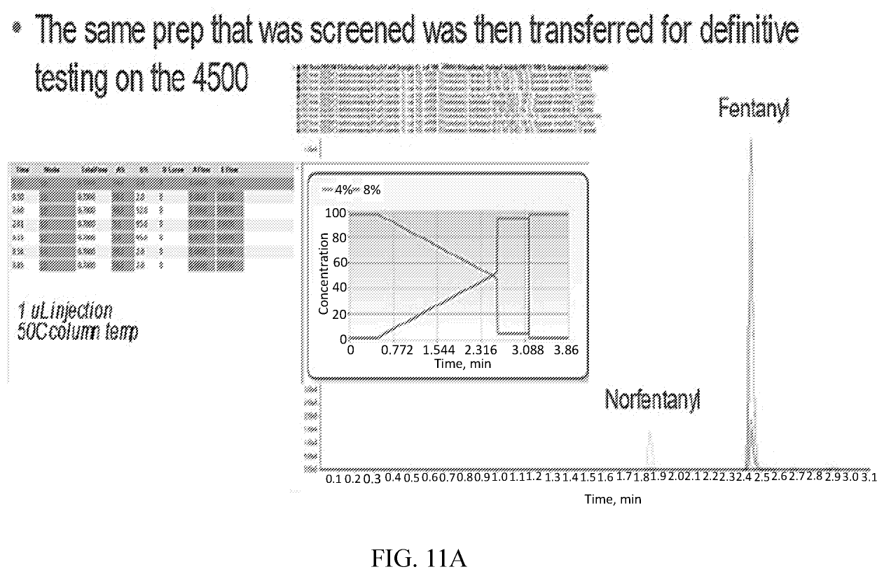

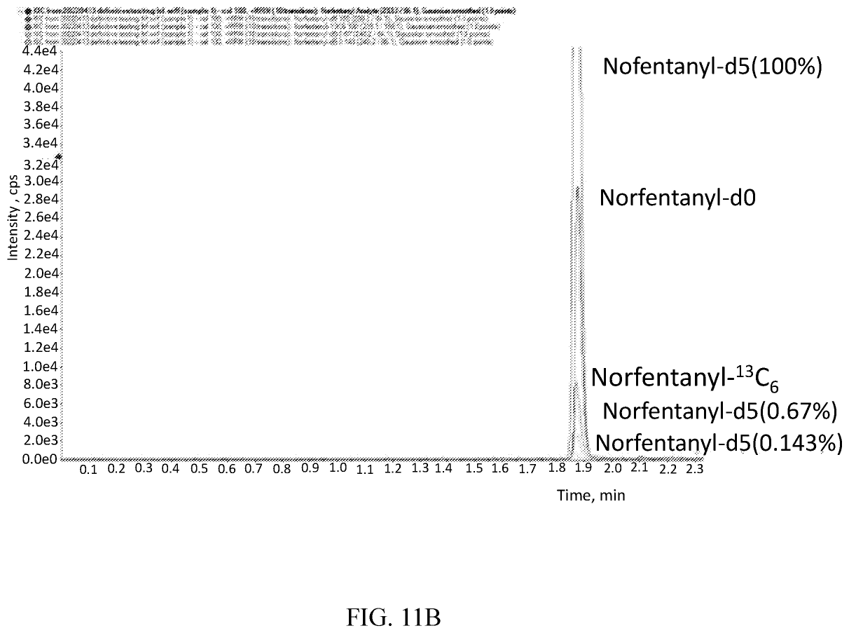

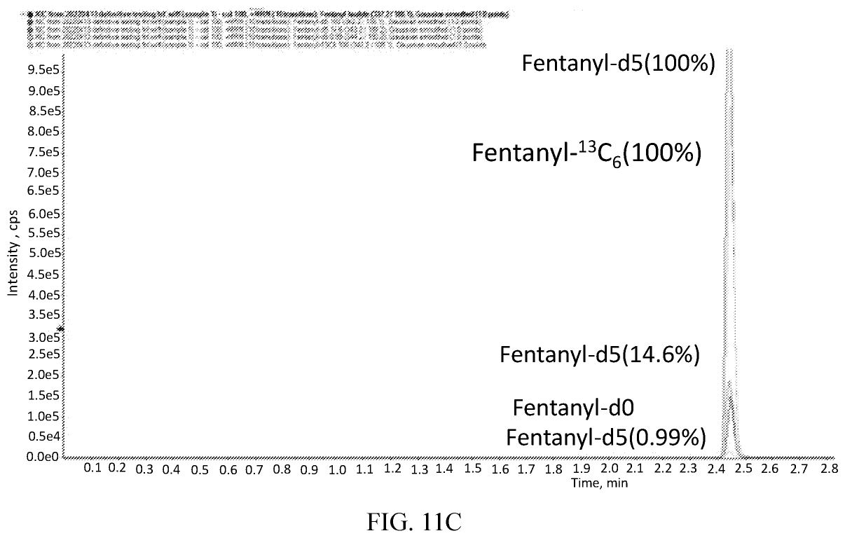

The analysis of samples with known concentrations of fentanyl and norfentanyl using AEMS with isotopologues for the internal standard and an internal calibration curve is shown in FIG. 6. The isotopologues used for the internal standard and the internal calibration curve generated peaks that were relatively of the same height for each particular transition. Analyte transitions produced variable peak height due to the different concentrations of the analyte within each sample. With AEMS, good quality, semi-quantitative results can be achieved in less than 8 minutes (FIG. 7). As shown in FIG. 8 and FIG. 9 the reproducibility for the internal standard isotopologue (FIG. 8) and the reproducibility for the isotopic transitions of the internal calibration isotopologue of fental-d5 at 100 ng/ml, 14.6 ng/ml, and 0.99 ng/ml (FIG. 9) were consistent throughout the run of over 100 unknown samples and quality control samples. A method comparison for fentanyl between the AEMS method and an LC-MS/MS reference method is shown in FIGS. 10A and 10B. In general, there was a positive correlation between the two methods, however, the correlation coefficient is relatively low. Additionally, FIG. 10B shows the percent difference chart for the comparison between the AEMS method and LC-MS/MS reference method. The results shown in FIG. 10A and FIG. 10B suggest that the present AEMS method is suitable for screening and semi-quantitative analysis, but is not suitable for use as a definitive quantitative analysis method. The samples prepared for analysis on the present AEMS method were then analyzed by an LC-MS/MS method with a gradient elution (FIGS. 11A-11C). The LC-MS/MS method separated the components within the prepared sample on a chromatography column, across a liquid chromatography gradient. FIG. 11A shows fentanyl and norfentanyl isotopic MRMs separated from one another while FIG. 11B and FIG. 11C show the detailed information of each isotopic MRM for norfentanyl (FIG. 11B) and fentanyl (FIG. 11C).

While the present disclosure has been described with reference to certain aspects, it will be understood by those skilled in the art that various changes may be made and equivalents may be substituted without departing from the scope of the present disclosure or appended claims. In addition, many modifications may be made to adapt a particular situation or material to the teachings of the present disclosure without departing from its scope. Therefore, it is intended that the present disclosure not be limited to the particular aspects disclosed, but that the present disclosure will include all aspects falling within the scope of the appended claims.

All patents, patent applications, publications, and descriptions mentioned above are herein incorporated by reference in their entirety.

1. A method for quantifying at least one analyte in a sample by mass analysis, the method comprising: yp2 adding a sample comprising an analyte of interest to a reaction mixture, the reaction mixture comprising at least a first labeled isotopologue and a second labeled isotopologue of the least one analyte of interest,
ionizing the resulting mixture,
monitoring, by mass spectrometry, at least one parent ion and/or at least one fragment ion of the analyte of interest, the first labeled isotopologue and/or the second labeled isotopologue, wherein the at least one fragment ion is selected from the group consisting of a product ion, an isotopic ion, a product ion transition, and an isotopic ion transition;
normalizing using the first labeled isotopologue;
determining intensity and/or using natural isotopic abundance of at least one parent ion and at least one fragment ion of the second labeled isotopologue;
generating an internal calibration curve based at least one product ion transition and/or at least one isotopic ion transition of the second labeled isotopologue; and
quantifying the at least one analyte present in the sample using the calibration curve;
wherein the reaction mixture further comprises magnetic beads,
wherein the magnetic beads are selected from the group consisting of mixed-phase magnetic beads, affinity ligand-conjugated magnetic beads, enzyme-conjugated magnetic beads, ion exchange magnetic beads, ferromagnetic beads, paramagnetic beads, superparamagnetic beads, and combinations thereof;
and wherein the sample is desalted using the mixed-phase magnetic beads.

2. The method of claim 1, wherein the first labeled isotopologue is used as an internal standard.

3. The method of claim 1, wherein the reaction mixture comprises at least a third labeled isotopologue, alternatively at least a fourth labeled isotopologue, alternatively at least a fifth labeled isotopologue and wherein the second labeled isotopologue, third labeled isotopologue, fourth labeled isotopologue, and/or fifth labeled isotopologue is used to generate an internal calibration curve.

4. (canceled)

5. The method of claim 1, wherein the first labeled isotopologue and second labeled isotopologue are labeled with at least one isotopic atom and wherein the isotopic atom of the first labeled isotopologue and the isotopic atom of the second labeled isotopologue are different.

6. (canceled)

7. (canceled)

8. The method of claim 1, wherein the normalization with first labeled isotopologue further comprises:
using peak area of the parent or product ion of the first labeled isotopologue and peak area of the parent or product ion of the analyte and/or the second labeled isotopologue to calculate a peak area ratio.

9. The method of claim 1, wherein the product ion transition has an intensity and/or abundance of about 100% and wherein the product ion transition is the most intense and/or abundant isotope of the at least one analyte.

10. (canceled)

11. The method of claim 9, wherein the intensity and/or abundance of the isotopic ion transition is less than about 100%, alternatively less than about 50%, alternatively less than about 25%, alternatively less than about 15%, alternatively less than about 10%, alternatively less than about 5% than a precursor and/or the product ion transition.

12-14. (canceled)

15. The method of claim 1, wherein intensity difference between the first labeled isotopologue and/or second labeled isotopologue and the analyte of interest are used as a response factor for signal intensity normalization.

16. The method of claim 15, wherein the first labeled isotopologue and/or second labeled isotopologue and the analyte of interest are at the same concentration.

17. (canceled)

18. The method of claim 1, wherein the method further comprises:
using the intensity and/or abundance of the at least one product ion transition and/or the at least one isotopic ion transition of the second labeled isotopologue to calculate a ratio of the at least one product ion transition and/or the at least one isotopic ion transition to the product and/or precursor, and
using the calculated ratio to calculate an isotopic dilution factor (IDF), wherein the IDF is used as a multiplier to compensate for high concentrations of analyte of interest.

19. (canceled)

20. (canceled)

21. The method of claim 1, wherein the mixed-phase magnetic beads are selected from C4 magnetic beads, C8 magnetic beads, C12 magnetic beads, C18 magnetic beads, cyanopropyl magnetic beads, phenyl magnetic beads, diphenyl magnetic beads, and combinations thereof and/or wherein the enzyme-conjugated magnetic beads are conjugated with trypsin, chymotrypsin, glucuronidase, or combinations thereof.

22. (canceled)

23. (canceled)

24. The method of claim 21, wherein the sample is digested and/or hydrolyzed using the enzyme-conjugated magnetic beads.

25. (canceled)

26. The method of claim 1, wherein the mass spectrometry is conducted using a mass analyzer, wherein the mass analyzer is coupled to a sample introduction device and wherein the sample introduction device comprises an acoustic droplet ejector (ADE), a solid phase extraction system, liquid-liquid extraction, protein precipitation, a liquid aspiration system, a microinjector, a nanoinjector, an inkjet printer nozzle, a chromatography instrument, microflow system, solid phase extraction system, differential mobility spectrometer, a trap-and-elute workflow, an open port interface, or direct flow injection.

27. (canceled)

28. (canceled)

29. The method of claim 26, wherein the sample introduction comprises acoustically ejecting the liquid sample into a mobile phase at an open port interface (OPI) using the acoustic droplet ejector (ADE).

30. (canceled)

31. The method of claim 26, wherein the mass analyzer is configured to perform a first mass analysis on the sample, wherein the first mass analysis is mass screening for an analyte of interest in the sample, and wherein if the analyte of interest is detected in the sample, the mass analyzer is configured to perform a second mass analysis, wherein the second mass analysis is a quantitative analysis.

32. The method of claim 31, wherein the mass analyzer is a tandem mass spectrometer.

33. The method of claim 31, wherein the first mass analysis is performed using a first mass analyzer and the second mass analysis is performed using a second mass analyzer.

34. The method of claim 33, wherein the first mass analyzer is a single-stage mass spectrometer or a tandem mass spectrometer and/or wherein the second mass analyzer is a tandem mass spectrometer.

35-39. (canceled)

40. The method of claim 1, wherein the method is used in a clinical analysis workflow, wherein the clinical analysis is used to screen for drugs of abuse, peptide markers for disease states, and/or peptides from proteins and/or analytes of interest.

42. The method of claim 40, wherein the drugs of abuse are selected from the group consisting of amphetamines, methamphetamines, benzodiazepines, barbiturates, marijuana, cocaine, PCP, methadone, opioids (narcotics), fentanyl, norfentanyl, gabapentin, and pregabalin.

43-47. (canceled)
